(19) United States
(12) Patent Application Publication
(10) Pub. No.: US 2007/0297780 A1
(43) Pub. Date: Dec. 27, 2007

(54) HAND-SHAKE QUANTITY DETECTOR

(75) Inventor: Shigeo ENOMOTO, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/765,606

(22) Filed: Jun. 20, 2007

(30) Foreign Application Priority Data
Jun. 21, 2006 (JP) 2006-170878

(51) Int. Cl. G03B 17/00

(52) U.S. Cl. 396/55

(57) ABSTRACT

A hand-shake quantity detector of an image blur correcting device comprises a rolling gyro sensor and a rolling gyro sensor base circuit board. The rolling gyro sensor detects an angular velocity regarding a rolling motion. The rolling gyro sensor base circuit board attaches the rolling gyro sensor. The rolling gyro sensor has a vibrator whose angular velocity detection axis is perpendicular to the rolling gyro sensor base circuit.

### BACKGROUND OF THE INVENTION

1. Field of the Invention

The present invention relates to a hand-shake quantity detector of an image blur correcting device for an optical apparatus, and in particular to a hand-shake detector that detects hand-shake quantity in three directions and whose gyro sensors can be mounted on one circuit board that has one plane.

2. Description of the Related Art

An image blur correcting device (An anti-shake apparatus) for an optical apparatus is proposed. The image blur correcting device reduces the hand-shake effect by moving a hand-shake correcting lens or an imaging sensor on a plane that is perpendicular to the optical axis, corresponding to the amount of hand-shake which occurs during imaging.

Japanese unexamined patent publication (KOKAI) No. 2005-351917 discloses an image blur correcting device that features a hand-shake detector having a pitching gyro sensor, a rolling gyro sensor, and a yawing gyro sensor to detect the hand-shake quantity, and having a movable unit that is rotatably and linearly moved in the xy plane for an anti-shake operation based on the hand-shake quantity.

However, in the case that all of the three gyro sensors have vibrator-type constructions whose angular velocity detection axes are parallel to the gyro sensor base circuit boards that attach the three gyro sensors respectively, all of the three gyro sensors cannot be mounted on one circuit board that is in one plane (see FIG. 7).

### SUMMARY OF THE INVENTION

Therefore, an object of the present invention is to provide a hand-shake quantity detector of an image blur correcting device that has three gyro sensors that detect the hand-shake quantity in three directions and that can be mounted on one circuit board that is in one plane.

According to the present invention, a hand-shake quantity detector of an image blur correcting device for an optical apparatus comprises a pitching gyro sensor, a rolling gyro sensor, and a yawing gyro sensor. The pitching gyro sensor detects a pitching angular velocity of the optical apparatus, and has a vibrator whose angular velocity detection axis is parallel to a pitching gyro sensor base circuit board to which the pitching gyro sensor is attached. The rolling gyro sensor detects a rolling angular velocity of the optical apparatus, and has a vibrator whose angular velocity detection axis is perpendicular to a rolling gyro sensor base circuit board to which the rolling gyro sensor is attached. The yawing gyro sensor detects a yawing angular velocity of the optical apparatus, and has a vibrator whose angular velocity detection axis is parallel to a yawing gyro sensor base circuit board to which the yawing gyro sensor is attached.

### BRIEF DESCRIPTION OF THE DRAWINGS

The objects and advantages of the present invention will be better understood from the following description, with reference to the accompanying drawings in which:

FIG. 1 is a perspective view of the photographing apparatus of the embodiment, viewed from the front side of the photographing apparatus;

FIG. 2 is a construction diagram of the photographing apparatus;

FIG. 3 is a circuit construction diagram of the anti-shake unit of the photographing apparatus;

FIG. 4 is a front view of the driving unit of the anti-shake unit;

FIG. 5 is a decomposed perspective view of the driving unit;

FIG. 6 is a perspective view of the driving unit; and

FIG. 7 is a perspective view of a photographing apparatus from the prior art, viewed from the front side of the photographing apparatus.

### DESCRIPTION OF THE PREFERRED EMBODIMENTS

The present invention is described below with reference to the embodiment shown in the drawings. In the embodiment, the photographing apparatus 1 is a digital camera. A photographing lens (not depicted), which is included in lens barrel 2 of the photographing apparatus 1 has an optical axis O.

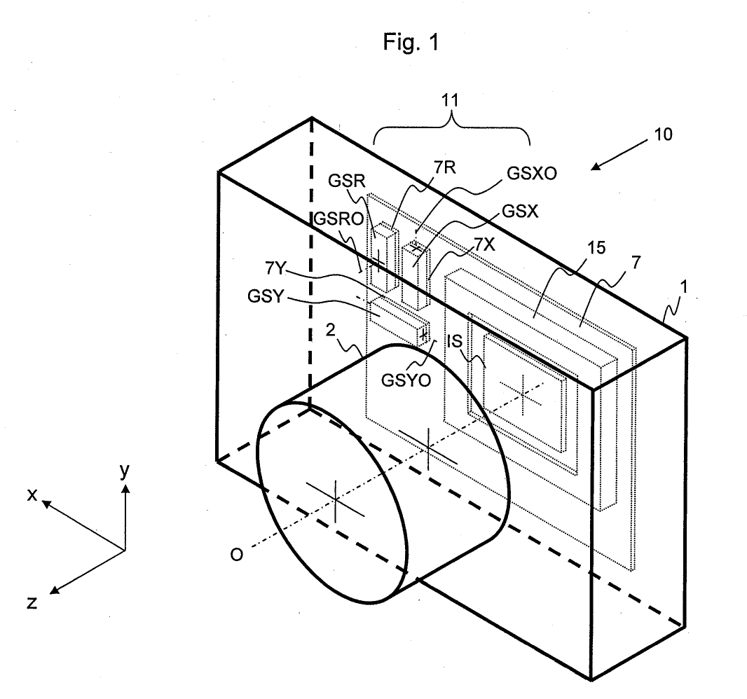

In order to explain the orientation in the embodiment, a first direction x, a second direction y, and a third direction z are defined (see FIG. 1). The first direction x is a direction which is perpendicular to the optical axis O. The second direction y is a direction which is perpendicular to the optical axis O and the first direction x. The third direction z is a direction which is parallel to the optical axis O and perpendicular to both the first direction x and the second direction y.

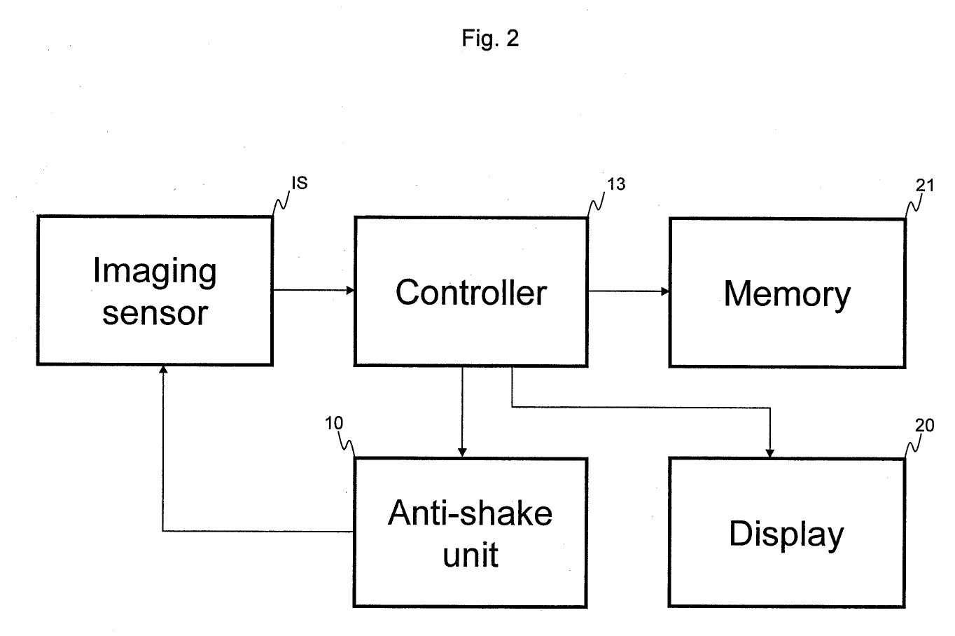

The photographing apparatus 1 has a lens barrel 2, and an imaging sensor IS (see FIG. 1). The photographing apparatus 1 has also an anti-shake unit 10, a controller 13, a display 20, and a memory 21 (see FIG. 2).

Tho photographic subject image is captured as an optical image through the photographing lens by the imaging sensor IS, such as a CCD etc., and the captured image is indicated on the display 20 after an A/D converting operation and an image processing operation have been completed by the controller 13.

Further, the image signal obtained by the imaging operation is stored in the memory 21.

The anti-shake unit 10 is an apparatus that reduces the effect of hand-shake, by linearly moving and rotating a movable unit 15a (a linear movement in the first direction x and in the second direction y, and a rotary movement in the xy plane), by canceling the lag corresponding to hand-shake quantity, of a photographic subject image on the imaging surface of the imaging sensor IS; and by stabilizing the photographic subject image that reaches the imaging surface of the imaging sensor IS.

The anti-shake unit 10 has a hand-shake quantity detector 11 that detects the quantity of hand-shake, and a driving unit 15 (an image blur correcting device) that moves the movable unit 15a, including a rotation of the movable unit 15a in the xy plane (the reference plane) perpendicular to the optical axis O, based on the hand-shake quantity. The movement of the movable unit 15a is based on the quantity of the hand-shake and is performed by the controller 13.

The hand-shake quantity detector 11 detects the hand-shake quantity by using an angular velocity sensor such as a gyro sensor etc. The hand-shake quantity detector 11 is attached to the main circuit board 7 of the photographing apparatus 1, which is in one plane and is parallel to the imaging surface of the imaging sensor IS.

The controller 13 has a first vertical error amplifier 63A, a second vertical error amplifier 63B, a horizontal error amplifier 65, a first vertical PID (Proportional, Integral, and Derivative controls) calculating circuit 66A, a second vertical PID calculating circuit 66B, a horizontal PID calculating circuit 68, a first vertical PWM driver 69A, a second vertical PWM driver 69B, and a horizontal PWM driver 71, in order to perform an anti-shake operation by using PID control.

The driving unit 15 has the movable unit 15a and a fixed unit 15b (see FIGS. 1, 4 and 5). The movable unit 15a is linearly movable and rotatable with regard to the fixed unit 15b that is fixed to the photographing apparatus 1, in the xy plane.

The movable unit 15a has a circuit board 45 to which the imaging sensor IS is attached, a first horizontal driving coil CXA, a second horizontal driving coil CXB, a first vertical driving coil CYA, a second vertical driving coil CYB, a first horizontal frame connecting unit FXA, a second horizontal frame connecting unit FXB, a first vertical hall sensor SYA, a second vertical hall sensor SYB, and a horizontal hall sensor SX.

The fixed unit 15b has a frame 18, a first vertical frame fixing unit FYA, a second vertical frame fixing unit FYB, a first horizontal driving and position-detecting yoke YXA, a second horizontal driving and position-detecting yoke YXB, a vertical driving and position-detecting yoke YY, a first horizontal driving and position-detecting magnet MXA, a second horizontal driving and position-detecting magnet MXB, a first-vertical driving and position-detecting magnet MYA, and a second vertical driving and position-detecting magnet MYB.

The back side of the fixed unit 15b or the driving unit 15 is attached to the main circuit board 7, and the front side of the fixed unit 15b is attached to the lens barrel 2.

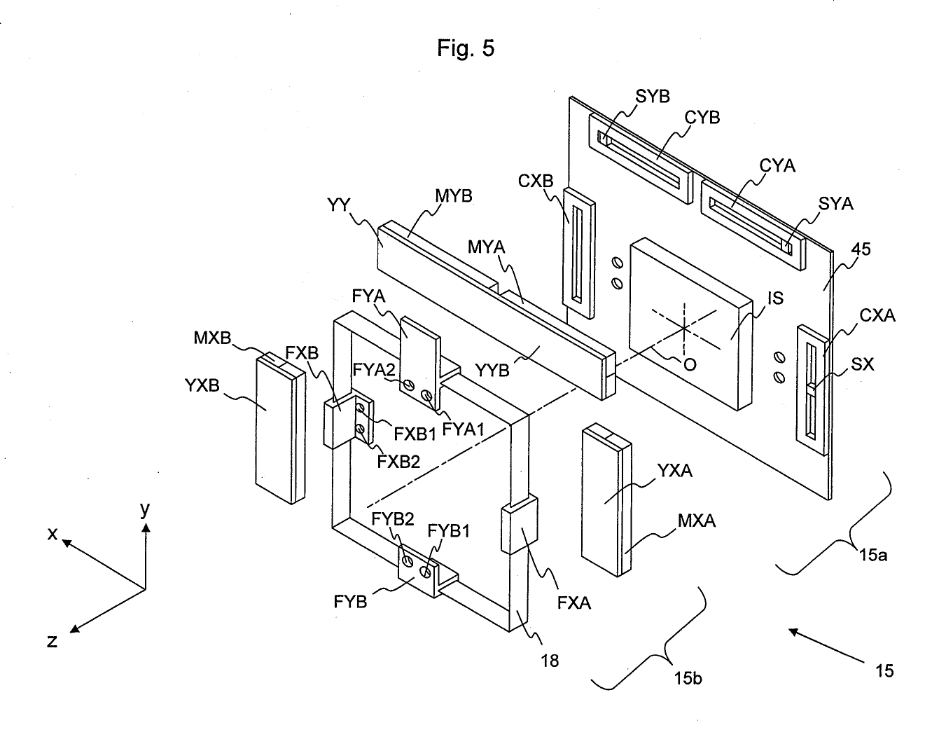

First of all, details of the handshake quantity detector 11 are explained (see FIGS. 1 and 5). The hand-shake quantity detector 11 has a pitching gyro sensor GSY, a rolling gyro sensor GSR, a yawing gyro sensor GSX, a pitching integrated circuit 60, a rolling integrated circuit 61, and a yawing integrated circuit 62.

The pitching gyro sensor GSY is arranged so that the angular velocity detection axis CSYO of tho pitching gyro sensor GSY is parallel to the first direction x, and detects the angular velocity of a rotary motion (the pitching motion) of the photographing apparatus 1 about the axis of the first direction x.

The rolling gyro sensor GSR is arranged so that the angular velocity detection axis GSRO of the rolling gyro sensor GSR is parallel to the third direction z, and detects the angular velocity of a rotary motion (the rolling motion) of the photographing apparatus 1 about the axis of the third direction z.

The yawing gyro sensor GSX is arranged so that the angular velocity detection axis GSXO of the yawing gyro sensor GSX is parallel to the second direction y, and detects the angular velocity of a rotary motion (the yawing motion) of the photographing apparatus 1 about the axis of the second direction y.

The pitching gyro sensor GSY, the rolling gyro sensor GSR, and the yawing gyro sensor CSX are respectively mounted on a pitching gyro sensor base circuit board 7Y, a rolling gyro sensor base circuit board 7R, and a yawing gyro sensor base circuit board 7X. The pitching gyro sensor base circuit board 7Y, the rolling gyro sensor base circuit board 7R, and the yawing gyro sensor base circuit board 7X are mounted on the main circuit board 7.

The pitching gyro sensor GSY is a vibratory gyro sensor such as a ceramic vibratory gyro sensor or an MEMS (Micro Electro Mechanical System) vibratory gyro sensor etc., that has a vibrator whose angular velocity detection axis GSYO is parallel to the pitching gyro sensor base circuit board 7Y. For example, a vibratory gyro sensor as manufactured by Murata Manufacturing Company, Ltd. (model number: ENC-03M), and a gyro sensor as manufactured by NEC TOKIN Corporation (model number: CG-L53), are cited.

The rolling gyro sensor GSR is a vibratory gyro sensor such as a quartz (crystal) oscillator gyro sensor etc., that has a vibrator whose angular velocity detection axis GSRO is perpendicular to the rolling gyro sensor base circuit board 7R. For example, a vibratory gyro sensor as manufactured by SEIKO EPSON Corporation (model number: XV3500CB) is cited.

The yawing gyro sensor GSX is a vibratory gyro sensor such as a ceramic vibratory gyro sensor or an MEMS vibratory gyro sensor etc., that has a vibrator whose angular velocity detection axis GSXO is parallel to the yawing gyro sensor base circuit board 7X.

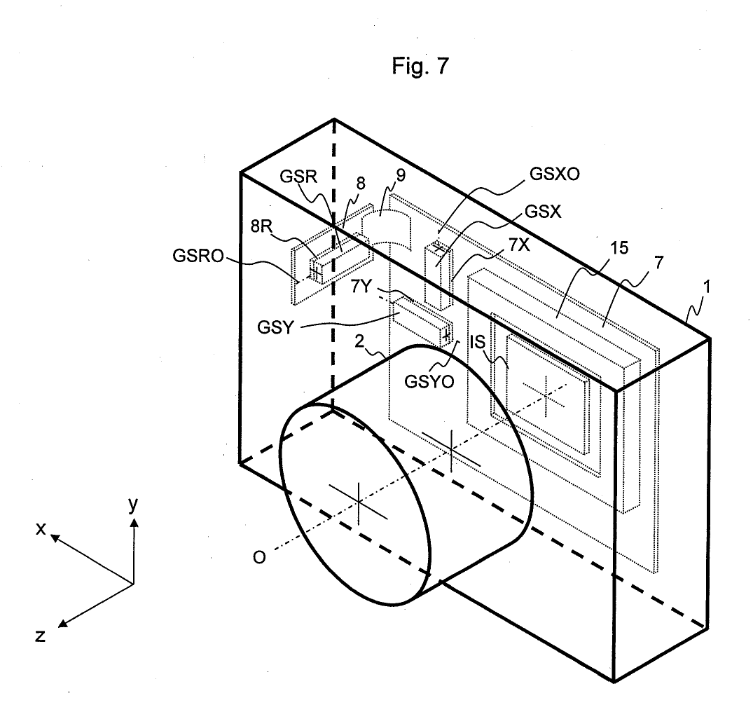

In the comparative case that the rolling gyro sensor GSR is a vibratory gyro sensor that has a vibrator whose angular velocity detection axis GSXO is parallel to the rolling gyro sensor base circuit board 7R, the rolling gyro sensor GSR cannot be mounted on the same circuit board (the main circuit board 7) as the pitching gyro sensor GSY and the yawing gyro sensor GSX (see FIG. 7). In this case, a sub circuit board 8 that is arranged perpendicular to the main circuit board 7 in order to mount the rolling gyro sensor 7R through a rolling gyro sensor base circuit board 8R, and a flexible circuit board 9 that electrically connects the main circuit board 7 and the sub circuit board 8, are necessary extra to the construction of the photographing apparatus 1.

However, in the embodiment, the rolling gyro sensor GSR can be mounted on the same circuit board (the main circuit board 7) as the pitching gyro sensor GSY and the yawing gyro sensor GSX, through the rolling gyro sensor base circuit board 7R (see FIG. 1).

Accordingly, because the sub circuit board 8 and the flexible circuit board 9 are not necessary, and because all these three gyro sensors can be mounted on the main circuit board 7, this embodiment is effective in downsizing the body of the photographing apparatus 1 and restraining the manufacturing costs.

The pitching integrated circuit 60 integrates a signal representing the angular velocity from the pitching gyro sensor GSY.

Based on the integrated signal, the pitching integrated circuit 60 generates a pitching angular signal Pyh as an output value corresponding to the angular hand-shake quantity based on the pitching motion.

The rolling integrated circuit 51 integrates a signal representing the angular velocity from the rolling gyro sensor GSR.

Based on the integrated signal, the rolling integrated circuit 61 generates a rolling angular signal Prh as an output value corresponding to the angular hand-shake quantity based on the rolling motion.

The yawing integrated circuit 62 integrates a signal representing tho angular velocity from the yawing gyro sensor GSX.

Based on the integrated signal, the yawing integrated circuit 62 generates a yawing angular signal Pxh as an output value corresponding to the angular hand-shake quantity based on the yawing motion.

The pitching angular signal Pyh is used for movement control of the movable unit 15a, based on the hand-shake quantity, by the controller 13, as a signal that specifies the hand-shake quantity based on the rotary motion (the pitching motion) about the axis of the first direction x.

The rolling angular signal Prh is used for movement control of the movable unit 15a, based on the hand-shake quantity, by the controller 13, as a signal that specifies the hand-shake quantity based on the rotary motion (the rolling motion) about the axis of the third direction z.

The yawing angular signal Pxh is used for movement control of the movable unit 15a, based on the hand-shake quantity, by the controller 13, as a signal that specifies the hand-shake quantity based on the rotary motion (the yawing motion) about the axis of the second direction y.

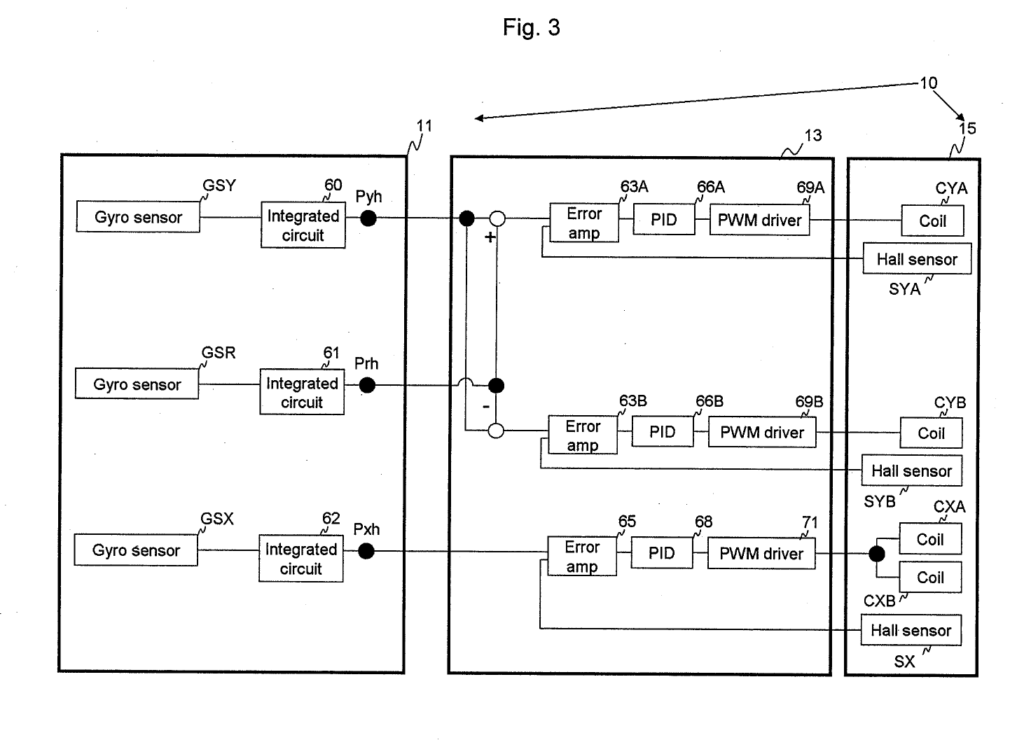

Next, the detail of the controller 13 is explained (see FIG. 3). In the case where a CPU is used as the controller 13, the operation of the integrated circuit, the error amplifier, the PID calculating circuits and the PWM driver can be performed by using software.

The pitching angular signal Pyh and the rolling angular signal Prh are input to the first vertical error amplifier 63A. The pitching angular signal Pyh and the rolling angular signal Prh are input to the second vertical error amplifier 63B.

The total value of the pitching angular signal Pyh and the rolling angular signal Prh, and an output value from the first vertical hall sensor SYA, are input to the first vertical error amplifier 63A.

The differential value between the pitching angular signal Pyh and the rolling angular signal Prh, and an output value from the second vertical hall sensor SYB are input to the second vertical error amplifier 63B.

The yawing angular signal Pxh and an output value from the horizontal hall sensor SX are input to the horizontal error amplifier 65.

The first vertical error amplifier 63A compares the total value of the pitching angular signal Pyh and the rolling angular signal Prh with the output value of the first vertical hall sensor SYA. Specifically, the first vertical error amplifier 63A calculates a differential value between this total value of the angular signals Pyh and Prh and this output value of the hall sensor SYA.

The second vertical error amplifier 63B compares the differential value between the pitching angular signal Pyh and the rolling angular signal Prh with the output value of the second vertical hall sensor SYB. Specifically, the second vertical error amplifier 63B calculates a differential value between this differential value of the angular signals Pyh and Prh and this output value of the hall sensor SYB.

The horizontal error amplifier 65 calculates the differential value between the yawing angular signal Pxh and the output value of the horizontal hall sensor SX.

The first vertical PID calculating circuit 66A performs a PID calculation based on the output value of the first vertical error amplifier 63A.

The second vertical PID calculating circuit 66B performs a LID calculation based on the output value of the second vertical error amplifier 63B.

Specifically, the first vertical PID calculating circuit 66A computes a voltage value to supply to the first vertical driving coil CYA to generate a PWM pulse duty ratio that effectively reduces the differential value between the total integrated value of the angular signals Pyh and Prh and the output value of the hall sensor SYA (effectively reducing the output value of the first vertical error amplifier 63A).

The second vertical PID calculating circuit 66B computes a voltage value to supply to the second vertical driving coil CYB to generate a PWM pulse duty ratio that effectively reduces the differential value between the differential value of the angular signals Pyh and Prh and the output value of the hall sensor SYB (effectively reducing the output value of the second vertical error amplifier 63B)

The first vertical PWM driver 69A applies a PWM pulse based on the effect of the calculation of the first vertical PID calculating circuit 66A, to the first vertical driving coil CYA.

The second vertical PWM driver 69B applies a PWM pulse based on the effect of the calculation of the second vertical PID calculating circuit 66B, to the second vertical driving coil CYB.

At the first and second vertical driving coils CYA and CYB, driving forces resulting from the application of the PWM pulse occur in the second direction y, so that the movable unit 15a can be moved in the second direction y in the xy plane based on the driving forces in the second direction y.

When the driving force that occurs in the first vertical driving coil CYA is different from the driving force that occurs in the second vertical driving coil CYB, the movable unit 15a is rotated in the xy plane based on the differential between the driving forces in the second direction y.

The horizontal PID calculating circuit 68 performs a PID calculation based on the output value of the horizontal error amplifier 65.

Specifically, the horizontal PID calculating circuit 68 computes a voltage value to supply to the first and second horizontal driving coils CXA and CXB to generate a PWM pulse duty ratio that effectively reduces the differential value between the yawing angular signal Pxh and the output value of the horizontal hall sensor SX (effectively reducing the output value of the horizontal error amplifier 65).

The horizontal PWM driver 71 applies a PWM pulse based on the effect of the calculation of the horizontal PID calculating circuit 68, to the first and second horizontal driving coils CXA and CXB.

At the first and second horizontal driving coils CXA and CXB, a driving force resulting from the application of the PWM pulse occurs in the first direction x, so that the movable unit 15a can be moved in the first direction x in the xy plane based on the driving force in the first direction x.

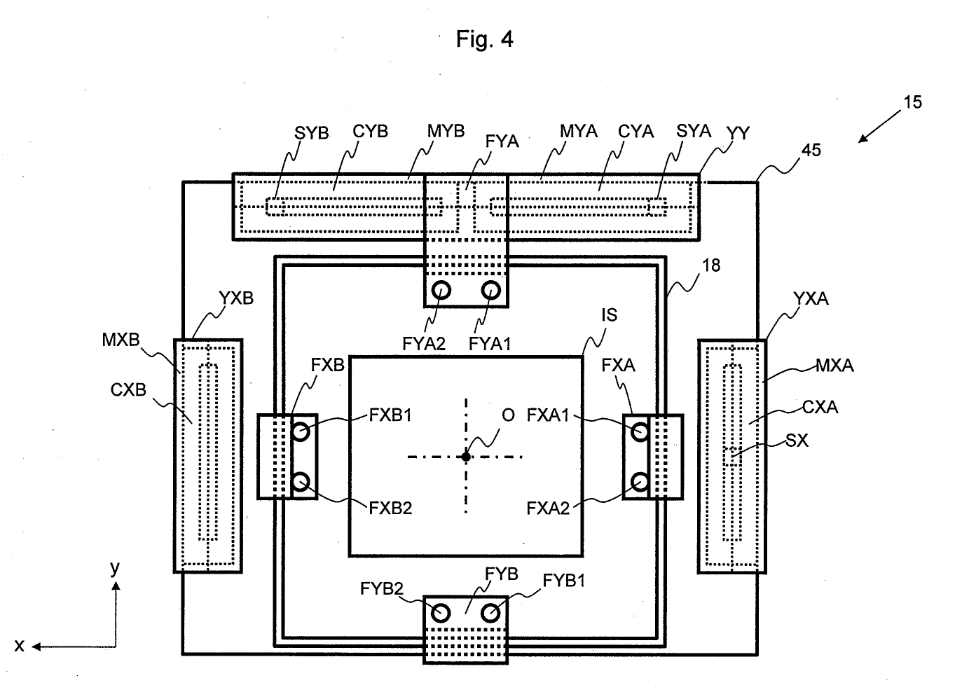

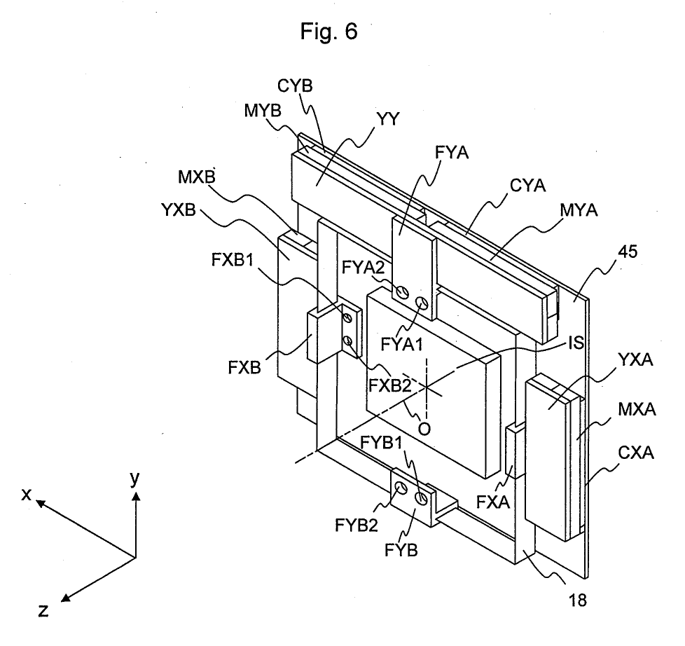

Next, the detail of the driving unit 15 is explained (see FIGS. 4 to 6). The first horizontal driving coil CXA, the second horizontal driving coil CXB, the first vertical driving coil CYA, the second vertical driving coil CYB, the first horizontal frame connecting unit FXA, the second horizontal frame connecting unit FXB, the first vertical hall sensor SYA, the second vertical hall sensor SYB, and the horizontal hall sensor SX are attached to the circuit board 45.

The frame 18 is a rectangular frame that is composed of four thin strips that are perpendicular to the xy plane, are a rectangular shape whose inside is hollow when viewed from the third direction z, and are non-magnetic elastic members. The strips have predetermined width, which is orientated in a direction perpendicular to the xy plane.

It is desirable that the four strips which form the frame 18 are made from one body. For example, the frame 18 is made by bending one long, thin strip and welding the two ends of the strip together, or by forming a section of tubular member into the rectangular shape.

The two strips of the frame 18 that face each other in the first direction x are attached to (connected with) the circuit board 45 through the first and second horizontal frame connecting units FXA and FXB. The other two strips of the frame 18 that face each other in the second direction y are attached to (fixed to) the fixed unit 15b (the lens barrel 2) with the first and second vertical frame fixing units FYA and FYB. The frame 18 surrounds the imaging sensor IS, or the imaging sensor IS is located in the inner side of the frame 18.

The first horizontal frame connecting unit FXA is attached to the circuit board 45 with tightening screws through the first horizontal frame connecting holes FXA1 and FXA2.

The second horizontal frame connecting unit FXB is attached to the circuit board 45 with tightening screws through the second horizontal frame connecting holes FXB1 and FXB2.

The first vertical frame fixing unit FYA is attached to the lens barrel 2 with tightening screws through the first vertical frame fixing holes FYA1 and FYA2.

The second vertical frame fixing unit FYB is attached to the lens barrel 2 with tightening screws through the second vertical frame fixing holes FYB1 and FYB2.

The frame 18 has a rectangular shape that has two horizontal sides parallel to the first direction x and two vertical sides parallel to the second direction y, when viewed from the third direction z. However, this rectangular shape is transformed elastically in the xy plane, corresponding to the movement of the circuit board 45 in the xy plane. Accordingly, the circuit board 45 is movably and rotatably supported in the xy plane by the fixed unit 15b and lens barrel 2 through the frame 18.

The first horizontal frame connecting unit FXA is attached to the center area of one of the two vertical sides (strips), parallel to the second direction y, of the frame 18.

The second horizontal frame connecting unit FXB is attached to the center area of the other of the two vertical sides (strips), parallel to the second direction y, of the frame 18.

The imaging sensor IS is arranged between the first and second horizontal frame connecting units FXA and FXB in the first direction x, when viewed from the third direction z.

The first vertical frame fixing unit FYA is attached to the center area of one of the two horizontal sides (strips), parallel to the first direction x, of the frame 18.

The second vertical frame fixing unit FYB is attached to the center area of the other of the two horizontal sides (strips), parallel to the first direction x, of the frame 18.

The imaging sensor IS is arranged between the first and second vertical frame fixing units PYA and PYB in the second direction y, when viewed from the third direction z.

The frame 18 is made from non-magnetic metal, and at least parts of the first and second horizontal frame connecting units FXA and FXB and the first and second vertical frame fixing units FYA and FYB are made from resin.

The frame 18, the first horizontal frame connecting unit FXA, the second horizontal frame connecting unit FXB, the first vertical frame fixing unit FYA, and the second vertical frame fixing unit FYB are formed by insert molding.

In the case that the frame 18 is made from resin, the first horizontal frame connecting unit FXA, the second horizontal frame connecting unit FXB, the first vertical frame fixing unit FYA, and the second vertical frame fixing unit FYB may be formed an united molding.

The first and second horizontal driving and position-detecting yokes YXA and YXB and the vertical driving and position-detecting yoke YY are board-shaped metallic magnetic members.

The first horizontal driving and position-detecting yoke YXA is arranged perpendicular to the third direction z, and attached (glued) to the lens barrel 2 on the right side when viewed from the third direction z and the lens barrel 2 side.

The second horizontal driving and position-detecting yoke YXB is arranged perpendicular to the third direction z, and attached (glued) to the lens barrel 2 on the left side when viewed from the third direction z and the lens barrel 2 side.

The vertical driving and position-detecting yoke YY is arranged perpendicular to the third direction z, and attached (glued) to the first vertical frame fixing unit FYA on the top side when viewed from the third direction z and the lens barrel 2 side.

The imaging sensor IS is arranged between the first and second horizontal driving and position-detecting yokes YXA and YXB in the first direction x, when viewed from the third direction z.

The first horizontal driving and position-detecting magnet MXA is attached to the first horizontal driving and position-detecting yoke YXA. The second horizontal driving and position-detecting magnet MXB is attached to the second horizontal driving and position-detecting yoke YXB. The first and second vertical driving and position-detecting magnets MYA and MYB are attached to the vertical driving and position-detecting yoke YY.

In an initial state before the movable unit 15a starts to move under the condition where it is not affected by gravity, namely when the imaging surface or the imaging sensor IS lies parallel to the horizontal plane (is facing upwards or downwards), it is desirable to have the circuit board 45 arranged such that the optical axis O passes through the center of the effective imaging field of the imaging sensor IS, two sides of a rectangle of the effective imaging field of the imaging sensor IS are parallel to the first direction x; the other two sides of the rectangle of the effective imaging field of the imaging sensor IS are parallel to the second direction y, and that the frame 18 is not transformed elastically and forms a rectangular shape.

The imaging sensor IS is arranged at the side of the circuit board 45 that faces the lens barrel 2.

The first horizontal driving coil CXA and the horizontal hall sensor SX face the first horizontal driving and position-detecting magnet MXA in the third direction z. The second horizontal driving coil CXB faces the second horizontal driving and position-detecting magnet MXB in the third direction z.

The first vertical driving coil CYA and the first vertical hall sensor SYA face the first vertical driving and position-detecting magnet MYA in the third direction z. The second vertical driving coil CYB and the second vertical hall sensor SYB face the second vertical driving and position-detecting magnet MYB in the third direction z.

The first and second horizontal driving and position-detecting magnets MXA and MXB are magnetized in the third direction z (in the thickness direction), the N pole and S pole of the first horizontal driving and position-detecting magnet MXA are arranged in the first direction x, and the N pole and S pole or the second horizontal driving and position-detecting magnet MXB are arranged in the first direction x.

The length of the first horizontal driving and position-detecting magnet MXA in the second direction y, is longer in comparison with the effective length of the first horizontal driving coil CXA in the second direction y, so that the first horizontal driving coil CXA and the horizontal driving sensor SX remain in a constant magnetic field throughout the movable unit's 15a full range of motion in the second direction y.

The length of the second horizontal driving and position-detecting magnet MXB in the second direction y, is longer in comparison with the effective length of the second horizontal driving coil CXB in the second direction y, so that the second horizontal driving coil CXB remains in a constant magnetic field throughout the movable unit's 15a full range of motion in the second direction y.

The first and second vertical driving and position-detecting magnets MYA and MYB are magnetized in the third direction z (in the thickness direction), the N pole and S pole of the first vertical driving and position detecting magnet MYA are arranged in the second direction y, and the N pole and S pole of the second vertical driving and position-detecting magnet MYB are arranged in the second direction y.

The length of the first vertical driving and position-detecting magnet MYA in the first direction x, is longer in comparison with the effective length of the first vertical driving coil CYA in the first direction x, so that the first vertical driving coil CYA and the first vertical hall sensor SYA remain in a constant magnetic field throughout the movable unit's 15a full range of motion in the first direction x.

The length of the second vertical driving and position-detecting magnet MYB in the first direction x, is longer in comparison with the effective length of the second vertical driving coil CYB in the first direction x, so that the second vertical driving coil CYB and the second vertical hall sensor SYB remain in a constant magnetic field throughout the movable unit's 15a full range of motion in the first direction x.

The coil pattern of the first horizontal driving coil CXA has a line segment which is parallel to the second direction y, so that the movable unit 15a, which includes the first horizontal driving coil CXA, moves in the first direction x when a horizontal electro-magnetic force is applied.

The coil pattern of the second horizontal driving coil CXB has a line segment which is parallel to the second direction y, so that the movable unit 15a, which includes the second horizontal driving coil CXB, moves in the first direction x when the horizontal electro-magnetic force is applied.

The horizontal electro-magnetic force occurs on the basis of the current that flows through the first horizontal driving coil CXA and the magnetic field of the first horizontal driving and position-detecting magnet MXA and on the basis of the current that flows through the second horizontal driving coil CXB and the magnetic field of the second horizontal driving and position-detecting magnet MXB.

The coil pattern of the first vertical driving coil CYA has a line segment which is parallel to the first direction x, so that the movable unit 15a, which includes the first vertical driving coil CYA, moves in the second direction y when a first vertical electro-magnetic force is applied.

The first vertical electro-magnetic force occurs on the basis of the current that flows through the first vertical driving coil CYA and the magnetic field of the first vertical driving and position-detecting magnet MYA.

The coil pattern of the second vertical driving coil CYB has a line segment which is parallel to the first direction x, so that the movable unit 15a, which includes the second vertical driving coil CYB, moves in the second direction y when a second vertical electro-magnetic force is applied.

The second vertical electro-magnetic force occurs on the basis of the current that flows through the second vertical driving coil CYB and the magnetic field of the second vertical driving and position-detecting magnet MYB.

The first vertical hall sensor SYA is a magneto-electric converting element (a magnetic field change-detection element) utilizing the Hall effect, and is used for detecting the position of the movable unit 15a in the second direction y by detecting a change in the magnetic-flux density from the first vertical driving and position-detecting magnet MYA, corresponding to a position change of the movable unit 15a in the second direction y.

The second vertical hall sensor SYB is a magneto-electric converting element (a magnetic field change-detection element) utilizing the Hall effect, and is used for detecting the position of the movable unit 15a in the second direction y by detecting a change in the magnetic-flux density from the second vertical driving and position-detecting magnet MYB, corresponding to a position change of the movable unit 15a in the second direction y.

The horizontal hall sensor SX is a magneto-electric converting element (a magnetic field change-detection element) utilizing the Hall effect, and is used for detecting the position of the movable unit 15a in the first direction x by detecting a change in the magnetic-flux density from the first horizontal driving and position-detecting magnet MXA, corresponding to a position change of the movable unit 15a in the first direction x.

The first vertical hall sensor SYA is arranged inside the first vertical driving coil CYA, the second vertical hall sensor SYB is arranged inside the second vertical driving coil CYB, and the horizontal hall sensor SX is arranged inside the first horizontal driving coil CXA. The first and second vertical hall sensors SYA and SYB are arranged so their separation is as large as possible.

The first horizontal driving and position-detecting yoke YXA prevents the magnetic field of the first horizontal driving and position-detecting magnet MXA from diffusing, and increases the magnetic-flux density between the first horizontal driving coil CXA and horizontal hall sensor SX, and the first horizontal driving and position-detecting magnet MXA.

The second horizontal driving and position-detecting yoke YXB prevents the magnetic field of the second horizontal driving and position-detecting magnet MXB from diffusing, and increases the magnetic-flux density between the second horizontal driving coil CXB and the second horizontal driving and position-detecting magnet MXB.

The vertical driving and position-detecting yoke YY prevents the magnetic field of the first vertical driving and position-detecting magnet MYA from diffusing, prevents the magnetic field of the second vertical driving and position-detecting magnet MYB from diffusing, increases the magnetic-flux density between the first vertical driving coil CYA and the first vertical hall sensor SYA, and the first vertical driving and position-detecting magnet MYA, and increases the magnetic-flux density between the second vertical driving coil CYB and second vertical hall sensor SYB, and the second vertical driving and position-detecting magnet MYB.

In the embodiment, the movable unit 15a can be movably and rotatably supported in the xy plane through the elastic transformation of the frame 18, without a guide mechanism or a mechanism that supports the movable unit 15a by using a ball. Therefore, because it is not necessary to consider a gap and wear based on the clearance of the guide mechanism, a highly accurate and highly stable anti-shake operation can be performed.

Further, the construction can be simplified compared to when a plurality of elastic members are used for movably supporting the movable unit 15a, and united molding or insert molding can be used, so the cost of production can be reduced.

In the embodiment, the elastic transformation of the frame 18 is used to move and rotate the movable unit 15a. However, to consider the elastic force of the frame 18 for the movement control of the movable unit 15a is not necessary, because the movement control method (the PID calculation or the controller 13) is a feedback control method that calculates the movement quantity (the driving force) required to move to the next position of the movable unit 15a on the basis of information regarding its present position; so it is not necessary to perform a complex calculation considering the elastic force.

In the embodiment, it is explained that the hall sensor is used for position detecting as the magnetic field change-detection element, however, another detection element may be used for position detecting on purposes. Specifically, the detection element may be an MI (Magnetic Impedance) sensor, in other words a high-frequency carrier-type magnetic field sensor, or a magnetic resonance-type magnetic field detection element, or an MR (Magneto-Resistance effect) element. When one of either the MI sensor, the magnetic resonance-type magnetic field detection element, or the MR element is used, the information regarding the position of the movable unit can be obtained by detecting the magnetic field change, similar to using the hall sensor.

Further, it is explained that the movement of the movable unit 15a is performed, on the basis of electro-magnetic force, from the magnet and the coil as an actuator. However, the movement of the movable unit 15a may be performed by another actuator.

Further, it is explained that the frame 18 is used as the supporting mechanism that movably and rotatably supports the movable unit 15a. However, the supporting mechanism may be another mechanism such as a guide mechanism or the mechanism that supports the movable unit 15a by using a ball.

Further, it is explained that the hand-shake quantity detector 11 is mounted on the main circuit board 7. However, it may be mounted on an exclusive circuit board for gyro sensors that is different from the main circuit board 7. In this case, the exclusive circuit board for gyro sensors can be easily attached to a part of the photographing apparatus 1 such as a wall of the photographing apparatus 1, through a buffer member that is used to prevent the effect of shock from the mirror up/down operation and the shutter open/close operation from reaching the vibratory gyro sensors.

Further, it is explained that the anti-shake unit 10 of the photographing apparatus 1 has the hand-shake quantity detector 11, however, another optical apparatus, such as the electric binocular that is described in U.S. Pat. No. 7,164,528, may have the hand-shake quantity detector 11.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2006-170878 (filed on Jun. 21, 2006) which is expressly incorporated herein by reference, in its entirety.

1. A hand-shake quantity detector of an image blur correcting device for an optical apparatus, comprising:
a pitching gyro sensor that detects a pitching angular velocity of said optical apparatus, and that has a pitching vibrator whose angular velocity detection axis is parallel to a pitching gyro sensor base circuit board that attaches said pitching gyro sensor;
a rolling gyro sensor that detects a rolling angular velocity of said optical apparatus, and that has a rolling vibrator whose angular velocity detection axis is perpendicular to a rolling gyro sensor base circuit board that attaches said rolling gyro sensor; and
a yawing gyro sensor that detects a yawing angular velocity of said optical apparatus, and that has a yawing vibrator whose angular velocity detection axis is parallel to a yawing gyro sensor base circuit board that attaches said yawing gyro sensor.

2. The hand-shake quantity detector according to claim 1, wherein said angular velocity detection axis of said pitching gyro sensor is parallel to a first direction that is perpendicular to an optical axis of a photographing lens of said optical apparatus;
said angular velocity detection axis of said yawing gyro sensor is parallel to a second direction that is perpendicular to said optical axis and said first direction; and
said angular velocity detection axis of said rolling gyro sensor is parallel to a third direction that is parallel to said optical axis and perpendicular to said first and second directions.

3. The hand-shake quantity detector according to claim 1, wherein said pitching gyro sensor is a ceramic vibratory gyro sensor or an MEMS vibratory gyro sensor; and
said yawing gyro sensor is a ceramic vibratory gyro sensor or an MEMS vibratory gyro sensor.

4. The hand-shake quantity detector according to claim 1, wherein said rolling gyro sensor is a quartz oscillator gyro sensor.

5. The hand-shake quantity detector according to claim 1, wherein said pitching gyro sensor base circuit board, said rolling gyro sensor base circuit board, and said yawing gyro sensor base circuit board are mounted on a common circuit board.

6. The hand-shake quantity detector according to claim 5, wherein said common circuit board is a main circuit board of said optical apparatus.

7. The hand-shake quantity detector according to claim 5, wherein said common circuit board is an exclusive circuit board for said pitching gyro sensor and said rolling gyro sensor and said yawing gyro sensor, that is different from a main circuit board of said optical apparatus.

8. A hand-shake quantity detector of an image blur correcting device, comprising
a rolling gyro sensor that detects an angular velocity regarding a rolling motion; and
a rolling gyro sensor base circuit board that attaches said rolling gyro sensor;
said rolling gyro sensor having a vibrator whose angular velocity detection axis is perpendicular to said rolling gyro sensor base circuit.

9. A hand-shake quantity detector of an image blur correcting device for an optical apparatus, comprising:
an imaging sensor that captures the photographic subject image as an optical image;
a pitching gyro sensor that detects a pitching angular velocity of said optical apparatus;
a rolling gyro sensor that detects a rolling angular velocity of said optical apparatus;
a yawing gyro sensor that detects a yawing angular velocity of said optical apparatus; and
a circuit board that attaches said pitching gyro sensor, said rolling gyro sensor, and said yawing gyro sensor, and that is parallel to an imaging surface of said imaging sensor.
